(19) United States
(12) Patent Application Publication
(10) Pub. No.: US 2018/0107328 A1
(43) Pub. Date: Apr. 19, 2018

(54) TOUCH INPUT DEVICE AND METHOD FOR CONTROLLING THEREOF

(71) Applicant: HYUNDAI MOTOR COMPANY, Seoul (KR)

(72) Inventors: Donghee SEOK, Seoul (KR); Gideok KWON, Seoul (KR); Jong Bok LEE, Suwon-si (KR)

(21) Appl. No.: 15/369,438

(22) Filed: Dec. 5, 2016

(30) Foreign Application Priority Data
Oct. 19, 2016 (KR) 10-2016-0135781

(51) Int. Cl. G06F 3/041; G06F 3/044; G06F 3/0488; H05B 3/03; H05B 3/06; B60K 37/06

(52) U.S. Cl. CPC G06F 3/0416; G06F 3/044; G06F 3/0488; B60K 2350/1024; H05B 3/06; B60K 37/06; G06F 2203/04103; H05B 3/03

(57) ABSTRACT

A touch input device includes at least one touch sensor receiving a touch command input, a hot wire electrode disposed in the at least one touch sensor to generate heat, a high frequency generator applying a high frequency to the hot wire electrode, and a controller allowing the high frequency to be applied to the hot wire electrode based on at least one of a predetermined heat generation order or a predetermined heat generation pattern.

### CROSS-REFERENCE TO RELATED APPLICATION(S)

This application claims the benefit of priority to Korean Patent Application No. 10-2016-0135781, filed on Oct. 19, 2016 in the Korean Intellectual Property Office, the disclosure of which is incorporated herein by reference.

### TECHNICAL FIELD

The present disclosure relates to a touch input device and a method for controlling thereof, more particularly, to a touch input device for inputting a touch command via a touch sensor in which an electrode is provided by using a laser processing, and for recognizing a character and a symbol from an electrode that is heated by applying a high frequency.

### BACKGROUND

A technology to implement a touch input device capable of performing a touch operation may include a resistive method, a capacitive method, a surface acoustic wave method, and a transmitter method.

A touch input device using the capacitive method includes electrode patterns extending in directions intersecting with each other to detect a change in the capacitance between the electrode patterns touched by an input means, e.g. a human finger, in order to identify an input position. Another type of the touch input device using the capacitive method identifies an input position in such a manner that an in-phase, equipotential current is applied between both ends of a transparent conductive film and a weak current, which is generated by the formation of a capacitor due to the approach or touch of an input means, e.g. a human finger, to the transparent conductive film, is detected.

A manufacturing method of a touch input device employs a method using a transparent electrode, i.e. indium tin oxide (ITO), a method using a metal mesh, and a method using a flexible printed circuit board (FPCB).

The touch input device is often used for an input-output device for visually-impaired users. Particularly, the touch input device has been used for mobile communication equipment for visually-impaired users having a variety of convenience functions, e.g. transmitting a braille character input and or recognizing received character or symbol as a braille character.

Recently, a study of a technology of installing an electrode by using a laser processing has been developed to efficiently implement a touch sensor structure without the limitation in the shape of the touch input device. In addition, a study of a touch input device has been progressed so that the visually-impaired users are able to recognize information by generation of heat in an electrode by using an application of high frequency.

### SUMMARY

An aspect of the present disclosure provides a touch input device that is implemented regardless of a shape of a touch sensor since the touch sensor is implemented by installing an electrode by using a laser processing so that visually-impaired users recognize braille while protecting privacy of the visually-impaired users by receiving information by heat generated in the electrode.

Additional aspects of the present disclosure will be set forth in part in the description which follows and, in part, will be obvious from the description, or may be learned by practice of the present disclosure.

In accordance with an exemplary embodiment of the present disclosure, a touch input device includes: at least one touch sensor receiving a touch command input; a hot wire electrode disposed in the at least one touch sensor to generate heat; a high frequency generator applying a high frequency to the hot wire electrode; and a controller allowing the high frequency to be applied to the hot wire electrode based on at least one of a predetermined heat generation order or a predetermined heat generation pattern.

The hot wire electrode may correspond to each of the at least one touch sensor.

The at least one touch sensor may include a pattern groove. The hot wire electrode is provided in the pattern groove.

The controller may allow the high frequency to be sequentially or simultaneously applied to the hot wire electrode based on at least one of the predetermined heat generation order or the predetermined heat generation pattern.

The hot wire electrode may generate heat according to a high frequency applied based on at least one of the predetermined heat generation order or the predetermined heat generation pattern.

The touch input device may further include: a memory storing data related to at least one of the predetermined heat generation order or the predetermined heat generation pattern.

The memory may store data related to characters and symbols corresponding to at least one of the predetermined heat generation order or the predetermined heat generation pattern.

The touch input device may further include: a button activating the at least one touch sensor to receive the touch command input.

The hot wire electrode may include a nichrome wire electrode.

The at least one touch sensor may receive the touch command input based on at least one of the predetermined heat generation order or the predetermined heat generation pattern.

In accordance with another exemplary embodiment of the present disclosure, a method for controlling a touch input device includes: activating at least one touch sensor; receiving a touch command input via the activated at least one touch sensor; applying a high frequency to a hot wire electrode provided in the touch sensor in response to the input touch command; and generating heat in the hot wire electrode based on the applied hot frequency.

The step of activating the at least one touch sensor may include: turning on a button, which activates the touch sensor, to receive the touch command input.

The step of receiving the touch command input may include: receiving the touch command input based on at least one of a predetermined heat generation order and heat generation pattern.

The step of applying the high frequency to the hot wire electrode may include: sequentially or simultaneously applying the high frequency to the hot wire electrode based on at least one of the predetermined heat generation order or the predetermined heat generation pattern.

In accordance with another exemplary of the present disclosure, a method for controlling a touch input device includes: generating a control signal to apply a high frequency to a hot wire electrode based on at least one of a predetermined heat generation order or a predetermined heat generation pattern; applying the high frequency to the hot wire electrode in response to the generated control signal; and generating heat in the hot wire electrode based on the applied hot frequency.

In accordance with one aspect of the present disclosure, a vehicle includes a touch input device which comprises: at least one touch sensor receiving a touch command input; a hot wire electrode disposed in the at least one touch sensor to generate heat; a high frequency generator applying a high frequency to the hot wire electrode; and a controller allowing the high frequency to be applied to the hot wire electrode based on at least one of a predetermined heat generation order or a predetermined heat generation pattern.

The touch input device may be disposed at a centralized control system in a gear box of the vehicle.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view illustrating a touch input device in accordance with one embodiment, and FIG. 2 is a perspective view illustrating a touch input device in accordance with another embodiment.

FIGS. 3 and 4 are cross-sectional views illustrating a hot wire electrode installed in the touch input device in accordance with one embodiment.

FIG. 5 is a cross-sectional view illustrating a pattern groove provided in the touch input device in accordance with one embodiment.

FIG. 6 is a side view illustrating the touch input device in accordance with one embodiment of the present disclosure.

FIG. 7 is a control block diagram illustrating the touch input device in accordance with one embodiment of the present disclosure.

FIG. 8 is a view illustrating predetermined braille data indicating characters and symbols in accordance with one embodiment of the present disclosure.

FIG. 9 is a schematic view illustrating a reception of information by an input of touch command or a heat generation of the touch sensor in accordance with one embodiment of the present disclosure.

FIG. 10 is a schematic view illustrating sequentially or simultaneously applying a high frequency to the hot wire electrode in accordance with one embodiment of the present disclosure.

FIGS. 11 and 12 are flowcharts illustrating a method for controlling the touch input device in accordance with one embodiment of the present disclosure.

FIG. 13 is a view illustrating a portable terminal in which the touch input device is provided in accordance with one embodiment of the present disclosure.

FIG. 14 is a view illustrating a door lock in which the touch input device is provided in accordance with one embodiment of the present disclosure.

FIG. 15 is a view illustrating a vehicle in which the touch input device is provided in accordance with one embodiment of the present disclosure.

### DETAILED DESCRIPTION

Exemplary embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

Terms used in the description are briefly explained and the prevent disclosure will be described in detail.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Some terms may be arbitrarily selected by the applicant, and in this case, the meaning of the selected terms will be described in detail in the detailed description of the disclosure. Thus, the terms used herein have to be defined based on the meaning of the terms together with the description throughout the specification.

When a part “includes” or “comprises” an element, unless there is a particular description contrary thereto, the part can further include other elements, not excluding the other elements. In the following description, terms such as “part”, “module” and “unit” indicate a unit for processing at least one function or operation, wherein the unit and the block may be embodied as software or hardware, such as field programmable gate array (FPGA), application specific integrated circuit (ASIC), or embodied by combining hardware and software. However, the term “part” “module” and “unit” are not limited to software or hardware. Further, “part” “module” and “unit” may be constructed to exist in an addressable storage module, or to play one or more processors. The terms “part” “module” and “unit” includes elements (e.g., software elements, object-oriented software elements, class elements and task elements), processors, functions, properties, procedures, subroutines, segments of a program code, drivers, firmware, a microcode, a circuit, data, a database, data structures, tables, arrays, and variables.

Embodiments of a touch input device and a method for controlling thereof will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure. Parts which are not associated with the description are omitted in order to specifically describe the present disclosure, and like reference numerals refer to like elements throughout the specification.

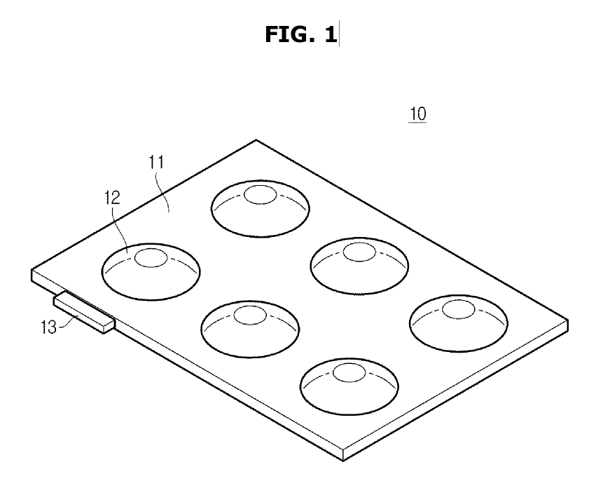

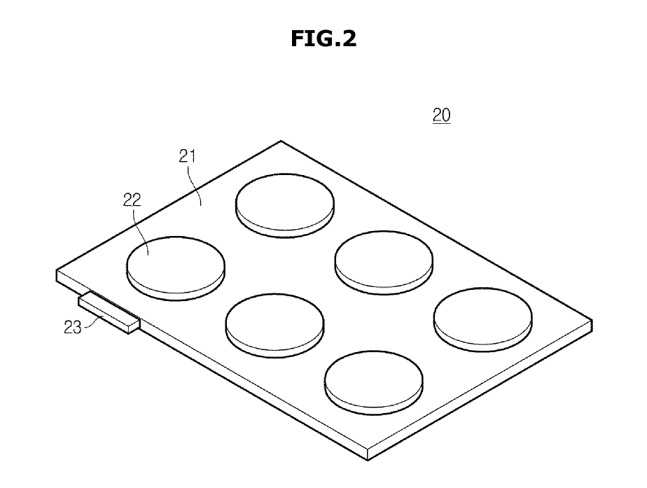

FIG. 1 is a perspective view illustrating a touch input device in accordance with one embodiment, and FIG. 2 is a perspective view illustrating a touch input device in accordance with another embodiment.

Referring to FIG. 1, a touch input device 10 may include a frame 11, at least one touch sensor 12 configured to receive an input of a touch command by a user and a button 13 configure to activate the touch sensor 12

There is no limitation in the number of the touch sensor 12 included in the touch input device 10, but it is assumed that the number of the touch sensor 12 is six according to the embodiment.

The touch sensor 12 may receive a touch command by making contact with an input means of user (i.e. a finger or a touch pen), and when the user comes in contact with the touch sensor 12 with the finger or the touch pen, the touch sensor 12 may detect whether to touch and which position to touch by detecting the change in the capacitance. The contact (touch) may be defined to include a direct contact and an indirect contact. That is, the direct contact may represent a case in which an object comes in contact with the touch sensor 12 and the indirect contact may represent a case in which an object approaches a range in which the detection pattern is able to detect the object, without making contact with the touch sensor 12.

As illustrated in FIG. 1, the touch sensor 12 may be implemented in a convex shape. That is, according to one embodiment, the touch sensor 12 of the touch input device 10 is a braille type sensor configured to allow visually-impaired users to read the touch sensor 12 with the their finger, and thus, the touch sensor 12 may be formed to be protruded on an upper surface of the frame 11.

As will be described later, an electrode installed in the touch sensor 12 may be installed by using a laser directing structure (LDS) method and thus the electrode may be installed in the touch sensor 12 regardless of a shape of the touch sensor 12, although the touch sensor 12 is in a convex shape or other shape. In addition, since an electrode is installed in the touch sensor 12, there may be no need of an additional structure to implement the braille type sensor and thus the manufacturing process may be simplified and the cost of the production may be reduced.

The frame 11 may be a structure in which the touch sensor 12 is provided, and the button 13, which activates the touch sensor 12, may be installed on one surface of the frame 11. A user may turn on the button 13 to input a touch command by using the touch input device 10 according to one embodiment, and the button 13 may act as a trigger to input a touch command.

After the user presses the button 13 to turn on the button 13, the user may input a touch command via the touch sensor 12, and while the user continuously presses the button 13, the user may input a touch command via the touch sensor 12.

In addition, when inputting the touch command via the touch sensor 12 is completed, the user may press the button 13 to inactivate the touch sensor 12 for the completion of the input. That is, when the touch sensor 12 is turned off since the user presses the button 13, the touch command may be not input although the user touches the touch sensor 12.

There may be no limitation in a position and a shape of the button 13 and the button 13 may be implemented in a physical button or a touch button to allow an input of the touch command.

Referring to FIG. 2, according to another embodiment, a touch input device 20 may include may include a frame 21, at least one touch sensor 22 configured to receive an input of a touch command by a user and a button 23 configure to activate the touch sensor 22.

As illustrated in FIG. 2, the touch sensor 22 may be implanted in a cylindrical shape, and the user may input a touch command by groping the touch sensor 22 with the hand and recognize information by the touch.

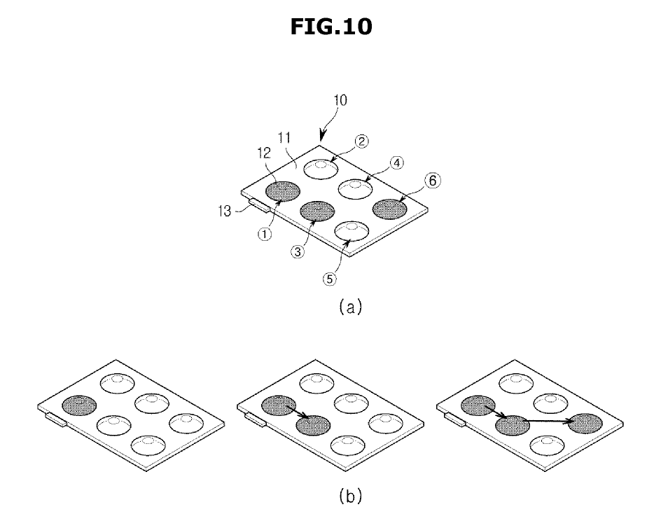

The structure of the touch input device 20 shown in FIG. 2 may be identical to the touch input device 10 shown in FIG. 10 other than the shape of the touch sensor 22, and a detail description thereof will be omitted.

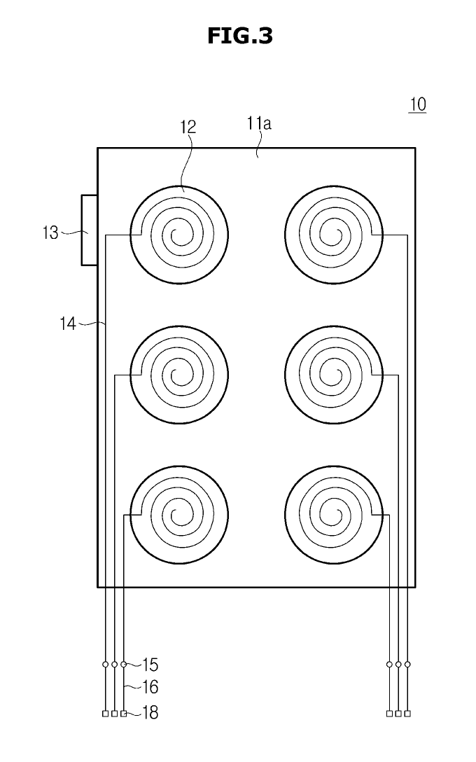

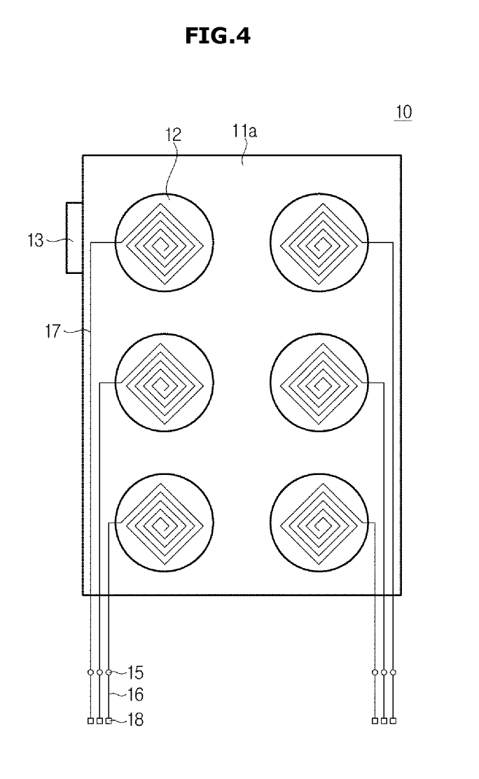

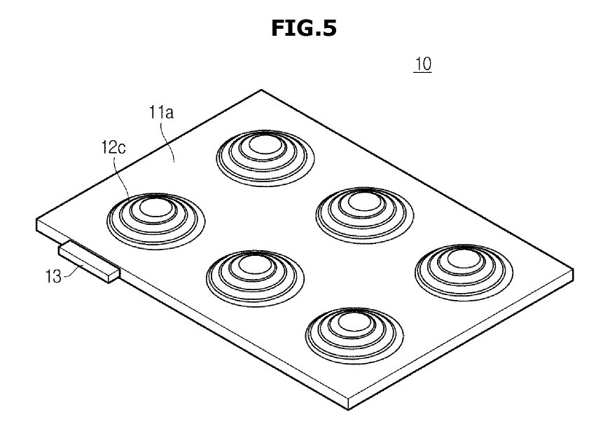

FIGS. 3 and 4 are cross-sectional views illustrating a hot wire electrode installed in the touch input device in accordance with one embodiment. FIG. 5 is a cross-sectional view illustrating a pattern groove provided in the touch input device in accordance with one embodiment.

Referring to FIG. 3, according to one embodiment, the touch sensor 12 of the touch input device 10 may include a hot wire electrode 14 and 17. The hot wire electrode 14 and 17 may be provided in the touch sensor 12 using the LDS method and may generate heat by a high frequency applied from a high frequency generator 40.

The hot wire electrode 14 and 17 may correspond to the touch sensor 12, and as illustrated in FIG. 3, the hot wire electrode 14 and 17 may generate heat in the touch sensor 12 so as to deliver the heat to a touch means in contact with the touch sensor 12.

As illustrated in FIG. 3, the hot wire electrode 14 and 17 may have a concentric circle or spiral shape, and as illustrated in FIG. 3, the hot wire electrode 14 and 17 may have a rhombus shape. The hot wire electrode 14 and 17 in a variety of shapes may be installed in the touch sensor 12 wherein the hot wire electrode 14 and 17 may have a variety of shapes as long as capable of delivering heat to a touch means in contact with the touch sensor 12 when a high frequency is applied. Hereinafter as for the touch input device 10 according to one embodiment, it is assumed that the hot wire electrode 14 is provided in the spiral shape show in FIG. 3, in the touch sensor 12.

Referring to FIG. 5, the touch sensor 12 may include a pattern groove 12c installed in the hot wire electrode 14. The pattern groove 12c may be formed on a convex surface of the touch sensor 12, and the hot wire electrode 14 may be plated on the pattern groove 12c.

The hot wire electrode 14 may be formed on the pattern groove 12c formed on the touch sensor 12 by using the LDS method. The LDS method represents a method in which forming a support material by using a material including a metal complex that is non-conductive and chemically stable, exposing a metal seed by breaking a chemical bonding of the metal complex by exposing a part of the support material to a laser, e.g. ultra violet (UV) laser or excimer laser, and then forming a conductive structure on a laser exposed part of the support material by metalizing the support material are performed.

The hot wire electrode 14 may be formed on the pattern groove 12c by an injection process, an etching process or a mechanical process. The hot wire electrode 14 may be formed of a conductive material, e.g. a metal. In consideration of the conductivity and the economic efficiency, copper (Cu) may be used among the metal and a nichrome wire made by alloying nickel (Ni) with chromium (Cr) may be used. However, it is also possible to use metal, e.g. gold (Au) to form the hot wire electrode 14.

Referring to FIG. 3, one end of the hot wire electrode 14 may be connected to the wiring unit 16 formed by a metal wiring. A connection pad 18 may be disposed on one end of the wiring unit 16, and the wiring unit 16 may be connected to a circuit board (not shown) via the connection pad 18.

Further, a connection unit 15 may be provided on one end portion of the hot wire electrode 14. Since a width of the connection unit 15 is wider than a width of the hot wire electrode 14, it may be easy to electrically connect the wiring unit 16 to the connection unit 15. The connection unit 15 and the wiring unit 16 may be adhered by a conductive adhesive (e.g. solder).

When the touch input means comes in contact with the touch sensor 12, capacitance may be reduced and information related to the capacitance may be delivered to the circuit board acting as a controller via the wiring unit 16 and the connection pad 18. Accordingly, the controller may receive an input of the touch command. Further, as the input means is closed to the touch sensor 12, capacitance may be reduced. In this case, the controller may determine which position to be closed by the input means.

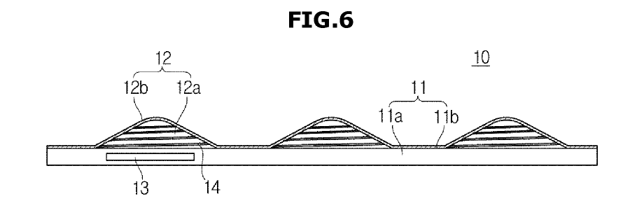

FIG. 6 is a side view illustrating the touch input device in accordance with one embodiment of the present disclosure.

Referring to FIG. 6, the frame 11 may include a base 11a and a first coating layer 11b. The first coating layer 11b may be coated on an upper end of the base 11a, and the first coating layer 11b may protect the base 11a, in which the hot wire electrode 14 is formed, from an external impact or contaminants. As illustrated in FIG. 6, an end of the hot wire electrode 14 provided in the touch sensor 12 may penetrate to the inside of the base 11a and then be connected to the connection unit 15 and the wiring unit 16 in the outside of the base 11a.

The base 11a may include a metal complex. For example, the base 11a may be a complex including resin and a metal oxide. The resin may include any one or more of polycarbonate (PC), polyamide (PA), and acrylonitrile-butadiene-styrene copolymer (ABS), and the metal oxide may include any one or more of Mg, Cr, Cu, Ba, Fe, Ti, and Al.

The touch sensor 12 may include a sensor injection object 12a and a second coating layer 12b. A pattern groove 12c in which the hot wire electrode 14 is installed may be formed on the sensor injection object 12a, and the pattern groove 12c may be formed by irradiating laser beams to the sensor injection object 12a. In this time, the pattern groove 12c may be reduced to a metal by heat generated during the groove is formed, and a part that is reduced to the metal may form a metal seed in the pattern groove 12c.

The hot wire electrode 14 may be formed by being plated on the pattern groove 12c. A process of plating on the metal seed may employ well-known plating techniques and thus a detailed description thereof will be omitted. The hot wire electrode 14 may be formed by a deposition process. Alternatively, the hot wire electrode 14 may be formed by a combination of the plating process and the deposition process.

The hot wire electrode 14 may include copper (Cu) plating, and nickel (Ni) may be plated on the copper plating for anti-oxidation treatment. In addition, when using gold (Au) plating, the conductivity may be improved.

As illustrated in FIG. 6, the hot wire electrode 14 may be arranged in the spiral shape along the pattern groove 12c formed on the convex surface of the sensor injection object 12a.

The second coating layer 12b may be coated on an upper end of the sensor injection object 12a, and the second coating layer 12b may protect the sensor injection object 12a, in which the hot wire electrode 14 is formed, from an external impact or contaminants.

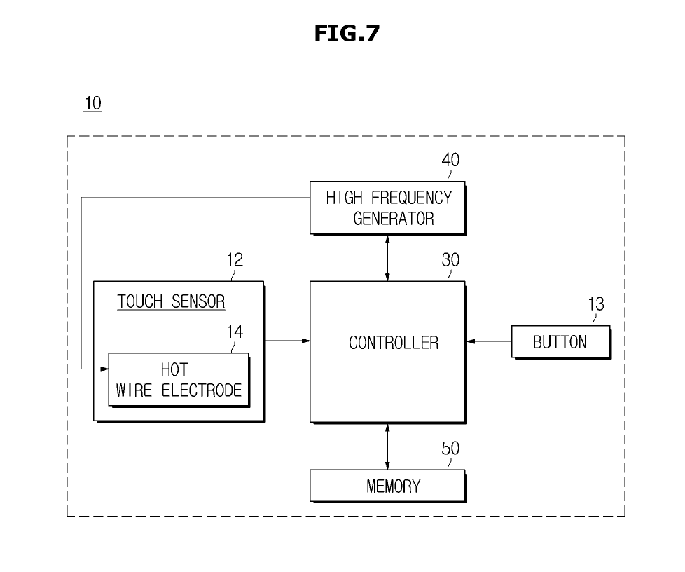

FIG. 7 is a control block diagram illustrating the touch input device in accordance with one embodiment of the present disclosure.

Referring to FIG. 7, the touch input device 10 may include the at least one of touch sensor 12 in which the hot wire electrode 14 is formed, the button 13 configured to activate the touch sensor 12, a controller 30 configured to generate a control signal based on a touch command input via the touch sensor 12 and to control to allow a high frequency to be applied to the hot wire electrode 14, the high frequency generator 40 configured to apply the high frequency to the hot wire electrode 14 and a memory 50 configured to store information related to the control of the touch input device 10.

The touch sensor 12 may include the hot wire electrode 14. The touch sensor 12 may receive an input of the touch command by the user and then transfer the touch command to the controller 30. Since the hot wire electrode 14 generates heat based on the control of the controller 30, a user who touches the touch sensor 12 may recognize information, e.g. a character or a symbol.

The button 13 may be installed on one surface of the frame 11 and function as a trigger configured to activate the touch sensor 12 so that the user is able to input a touch command.

The controller 30 may generate a control signal corresponding to a touch command based on the touch command input by the user. In addition, the controller 30 may control the high frequency generator 40 so that the high frequency generator 40 applies a high frequency to the hot wire electrode 14. In this time, the controller 30 may allow the high frequency generator 40 to apply the high frequency to the hot wire electrode 14 based on at least one of a predetermined heat generation order and heat generation pattern.

That is, when a user, e.g. visually impaired user, comes in contact with the touch sensor 12 of the touch input device 10 with a touch means, the user may detect heat transferred from the heated hot wire electrode 14 and then receive a character or a symbol. For this, the controller 30 may selectively apply a high frequency to the hot wire electrode 14 based on at least one of the heat generation order and the heat generation pattern, corresponding to information intended to be transferred.

The controller 30 may be implemented by in an array of a plurality of logic gates, or a combination of a general-purpose microprocessor and a memory in which program executed in the microprocessor is stored.

The high frequency generator 40 may apply a high frequency to the hot wire electrode 14 of the touch sensor 12 in response to the control of the controller 30.

The controller 30 may control to allow a high frequency to be selectively applied to the hot wire electrode 14 based on at least one of the heat generation order and heat generation pattern that is predetermined to transfer information e.g. a character or a symbol, to the user. Accordingly, the high frequency generator 40 may apply a high frequency AC signal having a frequency of 100 kHz to the hot wire electrode 14, the hot wire electrode 14 may generate heat and transfer the heat to the touch sensor 12, so that information is transferred to the user touching the touch sensor. However, a setting of the high frequency that is applied for heating the hot wire electrode 14 is not limited thereto.

The memory 50 may store data related to an operation of the touch input device 20. Particularly, the memory 50 may store information related to the heat generation order and the heat generation pattern of the hot wire electrode 14 included in the touch sensor 12. That is, the controller 30 may control to allow a high frequency to be selectively applied to the hot wire electrode 14 based on at least one of the heat generation order and heat generation pattern stored in the memory 50.

In addition, the memory 50 may store data related to a character and symbol corresponding to at least one of the predetermined heat generation order and heat generation pattern.

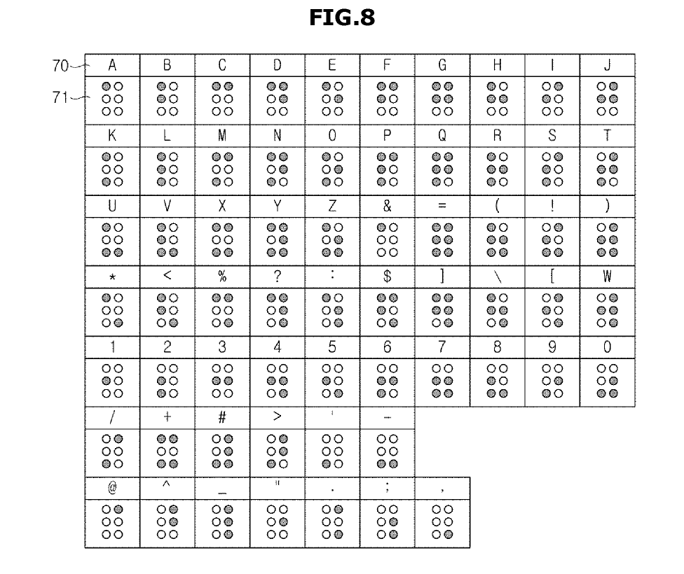

That is, in order to transfer information related to a certain character to the user, a heat generation pattern or heat generation order of the touch sensor 12 may be determined to illustrate the corresponding character and thus a selective heat generation of the hot wire electrode 14 may be determined based on information related to a correspondence between characters and the heat generation pattern or a correspondence between characters and the heat generation order. A detailed description thereof will be described with reference to FIGS. 8 to 10.

The memory 50 may include high-speed random access memory, magnetic disk, S-random access memory (RAM), D-RAM, and read only memory (ROM), but is not limited thereto. The memory 50 may be detachably installed to the vehicle. For example, the memory 50 may include compact flash (CF) card, secure digital (SD) card, smart media (SM) card, multimedia card (MMC) or memory stick.

FIG. 8 is a view illustrating predetermined braille data indicating characters and symbols in accordance with one embodiment of the present disclosure.

As mentioned above, according to one embodiment, the touch input device 10 may provide a method of inputting a character or a symbol or detecting a character or a symbol using braille.

Referring to FIG. 8, braille is system of characters widely used by visually-impaired individuals. A Braille character, or cell, is made up of six dot positions arranged in a rectangle containing two columns of three dots each.

As illustrated in FIG. 8, alphabet, numbers and symbols may be illustrated according to the number and position of raised dot among the six dots of data related to braille. Braille may be configured with a combination of a raised dot and a non-raised dot, and thus as for inputting braille character, inputting character or symbol may be performed by inputting a touch command to raise at least one dot in a selected position among the six dot position.

As illustrated in FIG. 8, data related to braille may be stored in the memory 50, e.g., the memory 50 may store both of character data 70 related to letter “A” and braille data 71 corresponding to the character data. The braille data may be configured with six dots and thus the braille data may correspond to the number and shape of the touch sensor 12 of the touch input device 10.

A user may input a touch command to correspond the braille data 71 via the touch sensor 12 of the touch input device 10, and the controller 30 may generate a control signal related to a character or symbol input by the user, based on a correspondence between the braille data and character or symbol data stored in the memory 50.

That is, as illustrated in FIG. 8, when the user touches the touch sensor 12 of the touch input device 10 in the same way of the braille data 71 corresponding to letter “A”, the controller 30 may generate a control signal related to letter “A”.

Further, the controller 30 may transfer information related to character or symbol to the user based on the correspondence between the braille data and character or symbol data stored in the memory 50. That is, the controller 30 may control to allow a high frequency to be selectively applied to the hot wire electrode 14 so that the touch sensor 12 in the same position as the braille data generates heat.

For example, the controller 30 may control to allow a high frequency to be selectively applied to the hot wire electrode 14 of the touch sensor 12 in the same position as the braille data 71 corresponding to letter “A” shown in FIG. 8. Therefore, when the touch sensor 12 corresponding to the hot wire electrode 14 generates heat since the high frequency is applied to the corresponding hot wire electrode 14, a user may detect information related to letter “A” by touching the touch sensor 12 with the touch means, e.g. a finger, without confirming with naked eyes.

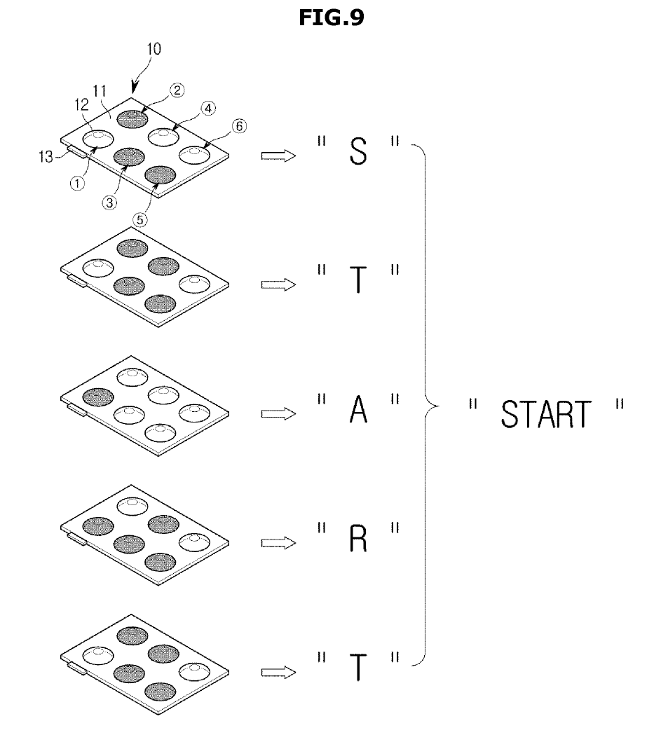

FIG. 9 is a schematic view illustrating a reception of information by an input of touch command or a heat generation of the touch sensor in accordance with one embodiment of the present disclosure.

Referring to FIG. 9, a user may input a touch command via the touch sensor 12 of the touch input device 10. That is, when the user sequentially or simultaneously touches the touch sensor 12, the controller 30 may generate a control signal related to the input character or symbol, based on the correspondence between the braille data and character or symbol data, as mentioned in FIG. 8.

As illustrated in FIG. 9, it is assumed that from number \textcircled{1} to number \textcircled{6} are given to the six touch sensors 12 provided in the touch input device 10. Based on the data shown in FIG. 8, letter “S” may be input by touching touch sensors \textcircled{2}, \textcircled{3} and \textcircled{5}. That is, when the user touches touch sensors \textcircled{2}, \textcircled{3} and \textcircled{5} of the touch input device 10, the controller 30 may generate a control signal related to letter “S”.

In the same way, when the user touches touch sensors \textcircled{2}, \textcircled{3}, \textcircled{4} and \textcircled{5} of the touch input device 10, the controller 30 may generate a control signal related to letter “T”, and when the user touches touch sensor \textcircled{1} of the touch input device 10, the controller 30 may generate a control signal related to letter “A”.

In addition, when the user touches touch sensors \textcircled{1}, \textcircled{3}, \textcircled{4} and \textcircled{5} of the touch input device 10, the controller 30 may generate a control signal related to letter “R”.

Therefore, the user may input a character corresponding to the predetermined pattern of the touch sensor 12 by touching the touch sensor 12 of the touch input device 10 in the above mentioned manner, and thus the user may input a touch command related to a word of “START”. In this case, there may be a time difference between a heat generation of the touch sensor 12 transferring each word, and the time difference may vary according to a user setting or a setting in the manufacturing process.

The controller 30 may transfer information related to a character or a symbol to the user based on the correspondence between the braille data and character or symbol data stored in the memory 50. That is, the controller 30 may control to allow a high frequency to be selectively applied to the hot wire electrode 14 so that the touch sensor 12 in the same position as the braille data generates heat.

Referring to FIG. 9, the controller 30 may control to allow a high frequency to be selectively applied to the hot wire electrode 14 of the touch sensor 12 in the same position as the braille data corresponding to letter “S”. Therefore, when the touch sensor 12 corresponding to the hot wire electrode 14 generates heat since the high frequency is applied to the corresponding hot wire electrode 14, the user may detect information related to letter “S” by touching the touch sensor 12 with the touch means, e.g. a finger, without confirming with naked eyes.

As mentioned above, based on the data shown in FIG. 8, since braille corresponding to letter “S” corresponds to the touch sensors \textcircled{2}, \textcircled{3} and \textcircled{5} of the touch input device 10, the controller 30 may control the high frequency generator 40 so that the high frequency generator 40 applies a high frequency to the hot wire electrode 14 provided in the touch sensors \textcircled{2}, \textcircled{3} and \textcircled{5}. That is, when the touch sensors \textcircled{2}, \textcircled{3} and \textcircled{5} are heated by the application of the high frequency, the user may detect information related to letter “S” by touching the touch sensors \textcircled{2}, \textcircled{3} and \textcircled{5}.

In the same way, in a state in which braille corresponding to letter “T” corresponds to the touch sensors \textcircled{2}, \textcircled{3}, \textcircled{4} and \textcircled{5} of the touch input device 10, when the touch sensors \textcircled{2}, \textcircled{3}, \textcircled{4} and \textcircled{5} are heated by the application of the high frequency to the touch sensor 12, the user may detect information related to letter “T” by touching the touch sensors \textcircled{2}, \textcircled{3}, \textcircled{4} and \textcircled{5}.

In a state in which braille corresponding to letter “A” corresponds to the touch sensor \textcircled{1} of the touch input device 10, when the touch sensor \textcircled{1} is heated by the application of the high frequency to the touch sensor 12, the user may detect information related to letter “A” by touching the touch sensor \textcircled{1}.

In the same way, in a state in which braille corresponding to letter “R” corresponds to the touch sensors \textcircled{1}, \textcircled{3}, \textcircled{4} and \textcircled{5} of the touch input device 10, when the touch sensors \textcircled{1}, \textcircled{3}, \textcircled{4} and \textcircled{5} are heated by the application of the high frequency to the touch sensor 12, the user may detect information related to letter “R” by touching the touch sensors \textcircled{1}, \textcircled{3}, \textcircled{4} and \textcircled{5}.

Therefore, the user may detect information related to a word of “START” by touching the touch sensor 12 heated in the above mentioned manner. In this case, there may be a time difference between a heat generation of the touch sensor 12 transferring each word, and the time difference may vary according to a user setting or a setting in the manufacturing process.

FIG. 10 is a schematic view illustrating sequentially or simultaneously applying a high frequency to the hot wire electrode in accordance with one embodiment of the present disclosure.

Referring to FIG. 10, the controller 30 may control to allow a high frequency to be sequentially or simultaneously applied to the hot wire electrode based on at least one of the predetermined heat generation order and heat generation pattern stored in the memory 50.

Based on the braille data shown in FIG. 8, when the touch sensors \textcircled{1}, \textcircled{3}, and \textcircled{6} of the touch input device 10 shown in FIG. 10 are heated, it may represent symbol “<”. That is, the controller 30 may transfer information related to symbol “<” to a user based on the correspondence between the braille data and character or symbol data stored in the memory 50.

According to the control of the controller 30, when the hot wire electrode 14 of the touch sensor 12 is heated, the controller 30 may allow a high frequency to be simultaneously applied to the hot wire electrode 14 provided in the touch sensors \textcircled{1}, \textcircled{3}, and \textcircled{6} so as to simultaneously heat the touch sensor 12, as illustrated in FIG. 10A.

Alternatively, the controller 30 may allow a high frequency to be sequentially applied to the hot wire electrode 14 provided in the touch sensor \textcircled{1}, \textcircled{3}, and \textcircled{6} so as to sequentially heat the touch sensor 12, as illustrated in FIG. 10B.

Simultaneously heating the touch sensor 12 or sequentially heating the touch sensor 12 may be determined by the user's setting or the setting in the manufacturing process. The user may detect information related to symbol “<” by detecting the heat generation in the touch sensors \textcircled{1}, \textcircled{3}, and \textcircled{6}.

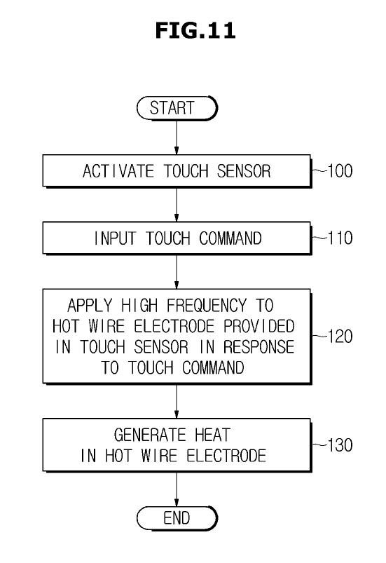

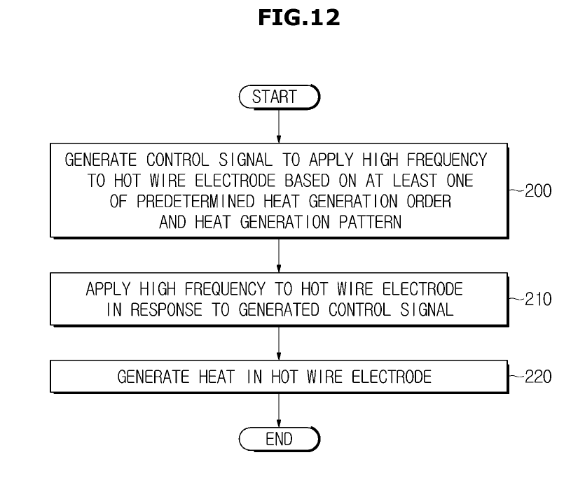

FIGS. 11 and 12 are flowcharts illustrating a method for controlling the touch input device in accordance with one embodiment of the present disclosure.

Referring to FIG. 11, a user may turn on the button 13 provided in the touch input device 10 and thus the touch sensor 12 may be activated (100). That is, the button 13 may act as a trigger to input a touch command, and thus when the touch sensor 12 is activated by the button 13 that is turned on, the user may input the touch command via the touch sensor 12 (110).

After the user presses the button 13 so that the button 13 is turned on, the user may input a touch command via the touch sensor 12, and alternatively, while the user continuously presses the button 13, the user may input a touch command via the touch sensor 12.

When the user inputs the touch command (110), the controller 30 may apply a high frequency to the hot wire electrode 14 provided in the touch sensor 12 in response to the input touch command (120) and thus the hot wire electrode 14 may be heated by the application of the high frequency (130).

That is, when it is needed that information is transferred to the user again, which is related to the touch command input by the user, the controller 30 may apply a high frequency to the hot wire electrode 14 provided in the touch sensor 12 based on at least one of the predetermined heat generation order and heat generation pattern stored in the memory 50, and then the user may detect information related to characters and symbols by touching the touch sensor 12.

Referring to FIG. 12, the controller 30 may generate a control signal to apply a high frequency to the hot wire electrode 14 based on at least one of the predetermined heat generation order and heat generation pattern (200). The controller 30 may control the high frequency generator 40 so that the high frequency generator 40 applies the high frequency to the hot wire electrode 14 according to the generated control signal (210), and thus, the hot wire electrode 14 may be heated by the application of the high frequency (220).

That is, the controller 30 may transfer information related to characters or symbols to the user based on the correspondence between the braille data and character or symbol data stored in the memory 50. For this, the controller 30 may control to allow a high frequency to be selectively applied to the hot wire electrode 14 so that the touch sensor 12 in the same position as the braille data is heated.

A detailed description thereof has been described with reference to FIGS. 8 to 10, and thus a duplicated description will be omitted.

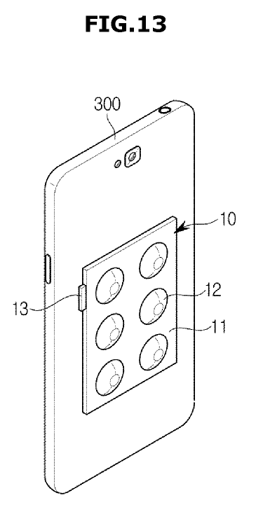

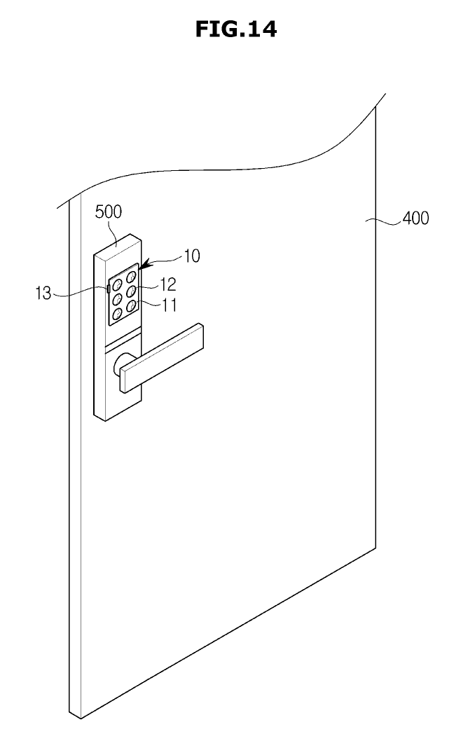

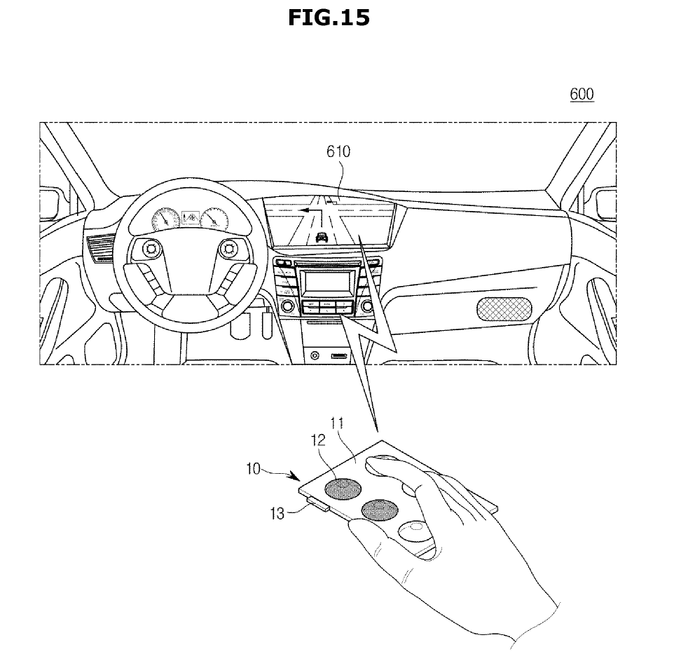

FIG. 13 is a view illustrating a portable terminal in which the touch input device is provided in accordance with one embodiment of the present disclosure, FIG. 14 is a view illustrating a door lock in which the touch input device is provided in accordance with one embodiment of the present disclosure, and FIG. 15 is a view illustrating a vehicle in which the touch input device is provided in accordance with one embodiment of the present disclosure.

Referring to FIG. 13, since the touch input device 10 according to one embodiment is installed in a portable terminal 300, the touch input device 10 may enable visually impaired users who have difficulty in recognizing a key pad required for an operation of the portable terminal, to input a character or a symbol.

Since it is possible to detect a character or a symbol by the touch input device 10, visually impaired users may be able to send and receive a text message by using the portable terminal 300 provided with the touch input device 10 and in addition the visually impaired users may be able to send and receive a variety of information by using the portable terminal 300.

That is, when the user inputs a touch command by using the touch sensor 12 of the touch input device 10 provided in the portable terminal 300, based on at least one of the predetermined heat generation order and heat generation pattern, the user may be able to input a character or a symbol corresponding to the touch command.

The user may receive the character or symbol corresponding to the predetermined heat generation order and heat generation pattern, by detecting the heat generation of the touch sensor 12 of the touch input device 10 provided in the portable terminal 300.

Referring to FIG. 14, since the touch input device 10 according to one embodiment is installed in a door lock 500 of a door 400, the touch input device 10 may enable visually impaired users who have difficulty in recognizing an input button required for opening and closing of the door lock 500, to input a password.

When the user inputs a touch command by using the touch sensor 12 of the touch input device 10 provided in the door lock 500, based on at least one of the predetermined heat generation order and heat generation pattern, the user may be able to input a number corresponding to the touch command.

Referring to FIG. 15, since the touch input device 10 according to one embodiment is installed in a vehicle 600, the touch input device 10 may enable visually impaired users who have difficulty in recognizing visual information displayed on a screen of a navigation system 610, to detect guide information of the navigation system 610.

Particularly, the navigation system 610 and the touch input device 10 may transmit and receive route guidance information via a wired and/or wireless communication, and the controller 30 of the touch input device 10 may selectively apply a high frequency to the hot wire electrode 14 of the touch sensor 12 based on the received route guidance information.

The user may detect the route guidance information of the navigation system 610 by a contact with the heated touch sensor 12 of the touch input device 10. As illustrated in FIG. 15, when a guidance of turning left is output from the navigation system 610, the controller 30 may transfer information related the symbol “<” to the user based on the correspondence between the braille data and character or symbol data stored in the memory 50, as illustrated in FIG. 10.

That is, by sequentially or simultaneously heating the hot wire electrode 14 provided in the touch sensors \textcircled{1}, \textcircled{3}, and \textcircled{6} of the touch input device 10 according to the control of the controller 30, it may be possible to transfer information related to turning left to the user. The user may detect information related to the symbol “<” by detecting the heat of the touch sensors \textcircled{1}, \textcircled{3}, and \textcircled{6}, so that the user recognizes that the route guidance information output from the 610 indicates turning left.

In addition, although not shown in the drawings, visually impaired users who have difficulty in recognizing the traffic sign in the road, with their naked eyes, and who have difficulty in determining a direction when walking the road, may receive direction information during walking, via the touch input device 10.

That is, while the user is walking with the touch input device 10, the user may receive route guidance information via the touch input device 10 connected to a route guidance system on the network via the wired and/or wireless communication. Particularly, the route guidance system connected to the touch input device 10 via the network may selectively apply a high frequency to the hot wire electrode 14 of the touch sensor 12 based on location information of the road in which the user walks.

The user may detect route guidance information by making contact with the heated touch input device 10. For example, when the user is needed to walk to the right side during walking, information related to a symbol “>” may be transferred to the user based on the correspondence between the braille data and character or symbol data stored in the route guidance system.

Accordingly, since the hot wire electrode 14 provided in the touch sensors \textcircled{2}, \textcircled{4} and \textcircled{5} of the touch input device 10 is simultaneously or sequentially heated, the user may receive information related to the right side.

As is apparent from the above description, according to the proposed touch input device, it may be easy to form a touch sensor to input a touch command although the touch input device has a curved surface, since the touch sensor is installed by using Laser Directing Structure (LDS) method. Particularly, although the touch input device has a double curved surface, an electrode may be formed thereon.

By receiving information by heat generated in the electrode of the touch sensor, visually-impaired users may recognize braille while protecting their privacy.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A touch input device comprising:
at least one touch sensor receiving a touch command input;
a hot wire electrode disposed in the at least one touch sensor to generate heat;
a high frequency generator applying a high frequency to the hot wire electrode; and
a controller allowing the high frequency to be applied to the hot wire electrode based on at least one of a predetermined heat generation order or a predetermined heat generation pattern.

2. The touch input device of claim 1, wherein
the hot wire electrode corresponds to each of the at least one touch sensor.

3. The touch input device of claim 1, wherein
the at least one touch sensor comprises a pattern groove, and
wherein the hot wire electrode is disposed in the pattern groove.

4. The touch input device of claim 1, wherein
the controller allows the high frequency to be sequentially or simultaneously applied to the hot wire electrode based on at least one of the predetermined heat generation order or the predetermined heat generation pattern.

5. The touch input device of claim 1, wherein
the hot wire electrode generates the heat according to a high frequency applied based on at least one of the predetermined heat generation order or the predetermined heat generation pattern.

6. The touch input device of claim 1, further comprising:
a memory storing data related to at least one of the predetermined heat generation order or the predetermined heat generation pattern.

7. The touch input device of claim 6, wherein
the memory stores data related to characters and symbols corresponding to at least one of the predetermined heat generation order or the predetermined heat generation pattern.

8. The touch input device of claim 1, further comprising:
a button activating the at least one touch sensor to receive the touch command input.

9. The touch input device of claim 1, wherein
the hot wire electrode comprises a nichrome wire electrode.

10. The touch input device of claim 1, wherein
the at least one touch sensor receives the touch command input based on at least one of the predetermined heat generation order or the predetermined heat generation pattern.

11. A method for controlling a touch input device, the method comprising steps of:
activating at least one touch sensor;
receiving a touch command input via the activated at least one touch sensor;
applying a high frequency to a hot wire electrode disposed d in the touch sensor in response to the input touch command; and
generating heat in the hot wire electrode based on the applied hot frequency.

12. The method of claim 11, wherein
the step of activating the at least one touch sensor comprises turning on a button which activates the touch sensor to receive the touch command input.

13. The method of claim 11, wherein
the step of receiving the touch command input comprises receiving the touch command input based on at least one of a predetermined heat generation order or a predetermined heat generation pattern.

14. The method of claim 11, wherein
the step of applying the high frequency to the hot wire electrode comprises sequentially or simultaneously applying the high frequency to the hot wire electrode based on at least one of the predetermined heat generation order or the predetermined heat generation pattern.

15. A method for controlling a touch input device, the method comprising steps of:
generating a control signal to apply a high frequency to a hot wire electrode based on at least one of a predetermined heat generation order or a predetermined heat generation pattern;
applying the high frequency to the hot wire electrode in response to the generated control signal; and
generating heat in the hot wire electrode based on the applied hot frequency.

16. A vehicle comprising a touch input device which comprises:
at least one touch sensor receiving a touch command input;
a hot wire electrode disposed in the at least one touch sensor to generate heat;
a high frequency generator applying a high frequency to the hot wire electrode; and
a controller allowing the high frequency to be applied to the hot wire electrode based on at least one of a predetermined heat generation order or a predetermined heat generation pattern.

17. The vehicle according to claim 16, wherein the touch input device is disposed at a centralized control system in a gear box of the vehicle.
